(19) United States
(12) Patent Application Publication
(10) Pub. No.: US 2017/0315990 A1
(43) Pub. Date: Nov. 2, 2017

(54) MULTILINGUAL TRANSLATION DEVICE AND MULTILINGUAL TRANSLATION METHOD

(71) Applicant: Mitsubishi Electric Corporation, Tokyo (JP)

(72) Inventor: Yuta KAWANA, Tokyo (JP)

(73) Assignee: Mitsubishi Electric Corporation, Tokyo (JP)

(21) Appl. No.: 15/531,911

(22) PCT Filed: Mar. 18, 2015
(86) PCT No.: PCT/JP2015/057985

§ 371 Date: May 31, 2017

(51) Int. Cl. G06F 17/28

(52) U.S. Cl. CPC G06F 17/289; G06F 17/2854

(57) ABSTRACT

An object of the present invention is multilingual translation with a low cost and high degree of accuracy. A multilingual translation device includes a translation request acquiring part that acquires a translation request to translate a character string to be translated of a first language into a second language, a character string extraction part that extracts, when a character string data of a second language is not stored in other language DB, a translation source character string corresponding to the character string to be translated from the other language DB for each of a plurality of languages whose character string data is stored in the other language DB, a translation part that translates the translation source character string into a third character string of the second language using a translation server, and a translation result selection part that selects a translation result from the third character string.

### TECHNICAL FIELD

The present invention relates to a multilingual translation device and a multilingual translation method.

### BACKGROUND ART

In order to achieve a global development of a device which displays information, the device needs to cause a language of a character string displayed on the device to correspond to multiple languages.

However, since a cost for translation, audio recording, and full-screen test, for example, is generated for each corresponding language, the cost increases with the increase in the corresponding language. It is therefore possible to cause the device to correspond to a language used by many speakers, however, it is difficult to cause the device to correspond to a language used by a few speakers.

Accordingly, a navigation device of Patent Document 1 corresponds to a certain number of languages by storing the character string, and when a user specifies a non-supported language other than the corresponding language, the navigation device performs a translation using a translation server.

### PRIOR ART DOCUMENTS

### Patent Documents

Patent Document 1: Japanese Patent Application Laid-Open No. 2013-36748

### SUMMARY

### Problem to be Solved by the Invention

The navigation device of the Patent Document 1 enables a cost reduction in corresponding to the multiple languages by appropriately using the translation server. However, there is a problem that a Web translation server generally has a low accuracy.

The present invention is made in consideration of the above problem, and it is an object of the present invention to provide a multilingual translation device and a multilingual translation method with a low cost and high degree of accuracy.

### Means to Solve the Problem

A multilingual translation device according to the present invention is a multilingual translation device that translates a character string displayed on a display, including: a processor to execute a program, a storage to store a character string data of a plurality of languages including a first language; and a memory to store the program which, when executed by the processor, performs processes including, acquiring a translation request to translate a first character string of a first language into a second language; extracting, when a character string data of the second language is not stored in the storage, a second character string corresponding to the first character string from the storage for each of a plurality of languages whose character string data is stored in the storage; translating the second character string into a third character string of the second language using a translation server; selecting a specific character string in the third character string as a translation result; acquiring a satisfaction level of a user to the translation result; storing the translation result and the satisfaction level in association with each other in the storage; and acquiring, when the translation result of the first character string of the first language translated into the second language is stored in the storage and a satisfaction level of the translation result is higher than a threshold value, the translation result from the storage without a translation performed by the translation server.

### Effects of the Invention

A multilingual translation device according to the present invention includes: a processor to execute a program, a storage to store a character string data of a plurality of languages including a first language; and a memory to store the program which, when executed by the processor, performs processes including, acquiring a translation request to translate a first character string of a first language into a second language; extracting, when a character string data of the second language is not stored in the storage, a second character string corresponding to the first character string from the storage for each of a plurality of languages whose character string data is stored in the storage; translating the second character string into a third character string of the second language using a translation server; selecting a specific character string in the third character string as a translation result; acquiring a satisfaction level of a user to the translation result; storing the translation result and the satisfaction level in association with each other in the storage; and acquiring, when the translation result of the first character string of the first language translated into the second language is stored in the storage and a satisfaction level of the translation result is higher than a threshold value, the translation result from the storage without a translation performed by the translation server. Since the translation server is used, the multilingual translation device which does not need to store the character string data for all of the corresponding languages in the storage and therefore is manufactured at low cost can be achieved. Since the translation is performed on the second character string of the plurality of languages, the translation accuracy can be improved. The translation result can be rapidly provided to the user using the result of the translation which has been performed previously.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 A block diagram illustrating a configuration of a multilingual translation device having a minimum configuration according to a multilingual translation device of the present invention.

FIG. 2 A block diagram illustrating a configuration of a multilingual translation device according to an embodiment 1 of the present invention.

FIG. 3 A view illustrating a hardware configuration of the multilingual translation device according to the embodiment 1 of the present invention.

FIG. 4 A flow chart showing a processing that a navigation device acquires a translation request and then transmits the translation request to a translation result providing server.

FIG. 5 A flow chart showing a processing that the translation result providing server receives the translation request from the navigation device and then transmits the translation result to the navigation device.

FIG. 6 A flow chart showing a detail of a selection processing of the translation result.

FIG. 7 A flow chart showing a subsequent processing of an in-vehicle device which has transmitted the translation request to the multilingual translation device.

FIG. 8 A block diagram illustrating a configuration of a multilingual translation device according to a modification example.

### DESCRIPTION OF EMBODIMENT(S)

### A. Embodiment 1

### A-1. First Configuration

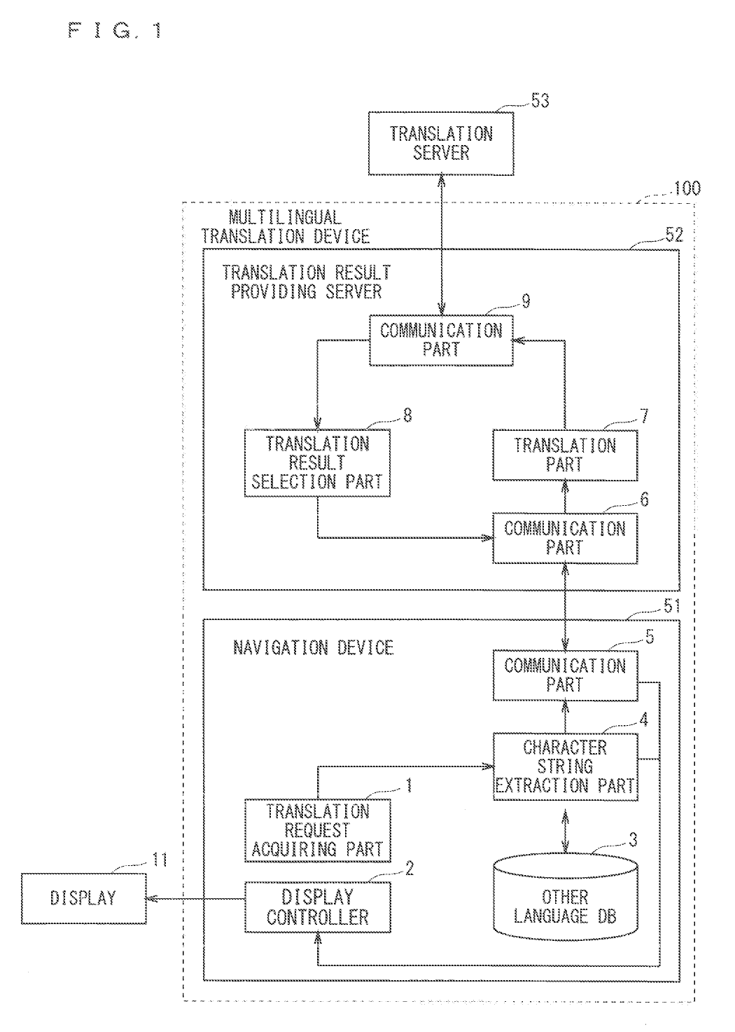

FIG. 1 is a block diagram illustrating a configuration of a multilingual translation device 100 having a first configuration according to a multilingual translation device of the present invention. The multilingual translation device 100 includes a navigation device 51 and a translation result providing server 52 communicating with the navigation device 51.

Herein, the navigation device 51 is one example of an in-vehicle device. In the present description hereinafter, the multilingual translation device 100 is described by taking the navigation device 51 as an example, however, the multilingual translation device 100 is not limited to the navigation device 51 but any information communication device may also be applied as long as it is mounted on a vehicle to perform a display control of a display 11 which is also mounted on the vehicle. A device “mounted on the vehicle” in the present description includes not only a device constantly mounted on the vehicle but also a device brought and used in the vehicle as needed.

The navigation device 51 includes a translation request acquiring part 1, a display controller 2, other language data base (DB) 3, a character string extraction part 4, and a communication part 5. The translation request acquiring part 1 acquires a translation request of a user. The translation request includes a character string to be translated and a designation of a translation destination language. The display controller 2 performs a display control of the display 11 and causes the display 11 to perform various displays of the navigation device 51. The other language DB 3 stores a character string data of a plurality of languages. When the other language DB 3 does not store the character string data of the translation destination language in the translation request, the character string extraction part 4 extracts the character string, which corresponds to the character string to be translated (translation source character string), for each of the plurality of languages whose character string data is stored in the other language DB 3 from the other language DB 3. The communication part 5 includes the character string extracted by the character string extraction part 4 in the translation request and transmits it to the translation result providing server 52.

The translation result providing server 52 includes communication parts 6 and 9, a translation part 7, and a translation result selection part 8. The translation part 7 translates the translation source character string into the character string of the translation destination language using the translation server 53. The translation result selection part 8 selects a specific character string from among the character strings translated in the translation server 53 as the translation result. The character string selected in the translation result selection part 8 is transmitted from the communication part 6 to the communication part 5 of the navigation device 51, and is then displayed on the display 11 under the display control of the display controller 2.

The translation server 53 is a Web translation server published on the Web, for example.

### A-2. Second Configuration

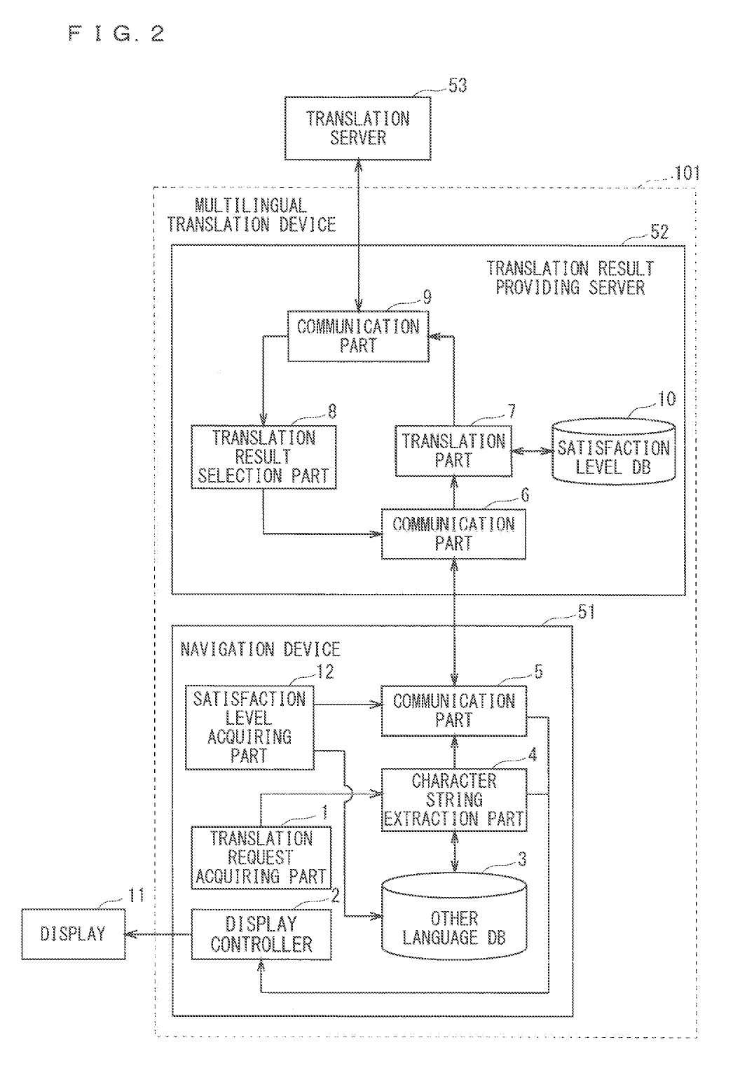

FIG. 2 is a block diagram illustrating a configuration of a multilingual translation device 101 having a second configuration according to the embodiment 1 of the present invention. The multilingual translation device 101 includes a satisfaction level DB 10 and a satisfaction level acquiring part 12 in addition to the configuration of the multilingual translation device 100. A whole configuration of the multilingual translation device 101 is described hereinafter.

The display 11 is mounted on a vehicle on which the navigation device 51 is mounted and performs the display under the control of the navigation device 51. Although FIG. 2 illustrates the display 11 as a configuration separated from the navigation device 51, the display 11 may be included in the navigation device 51. The display 11 displays a map screen and a point search screen as well as a menu screen in accordance with a function of the navigation device 51.

The translation request acquiring part 1 acquires the translation request. For example, considered is a case where the display 11 displays the menu screen. The menu screen generally includes a plurality of buttons, and a character which indicates an operation content such as “display map” or “search destination” is displayed in each button.

The other language DB 3 stores the data of character strings (the character string data) displayed on the display 11 for the plurality of languages. When the user specifies, in a default setting of the navigation device 51, one language which the user understands from the languages whose character string data is stored in the other language DB 3, various displays of the navigation device 51 are performed in the specified language.

Accordingly, the character string data of many languages is preferably stored in the other language DB 3 to cause various users to select a familiar language. However, a manufacturing cost such as a translation cost increases with the increase in the character string data of many languages stored in the other language DB 3 to correspond to the multiple languages. The other language DB 3 therefore stores the language spoken by many people on a global basis and the language spoken by many people in a target market, for example.

The user whose native language is not stored in the other language DB 3 specifies one language which the user can understand from the languages stored in the other language DB in the default setting, thereby using the navigation device 51. The language specified by the user herein is referred to as a first language.

However, the user may not understand the meaning of the character string displayed in the first language on the display 11. In such a case, the user specifies the character string (a first character string) and performs the translation request so that the character string is translated into the language which the user can understand. That is to say, the translation request includes a character string to be translated and a translation designation language (a second language). It is also applicable that the translation designation language is specified by the user at a time of the default setting of the navigation device 51 and the translation request acquiring part 1 has information thereof.

The translation request acquisition part 1 acquires the above translation request being input by the user from an input interface, which is not shown in the drawing, in the navigation device 51. The input interface may be made up of a button provided in a housing or a remote controller, for example, of the navigation device 51. Alternatively, when the display 11 has a configuration of a display provided with a touch panel, the user may perform a touch operation or a drag operation on the touch panel to specify the character string which is intended to be translated. That is to say, the display 11 doubles as the input interface.

When the character string extraction part 4 acquires the translation request from the translation request acquisition part 1, the character string extraction part 4 extracts, from the other language DB 3, the character strings of the plurality of languages corresponding to the character strings to be translated, and then transmits them to the communication part 5. For example, when the other language DB 3 stores the character strings of English, Japanese, German, and Arabic and the character string to be translated is an English character string of “map display”, the character string extraction part 4 extracts the character strings in Japanese, German, and Arabic, each of which means “map display” from the other language DB 3. The character string extracted from the other language DB 3 is hereinafter referred to as the translation source character string (a second character string) to be distinguished from the character string to be translated. However, since the character string to be translated is stored in the other language DB 3, the character string to be translated (the English character string of “map display” in the above example) may also be included in the translation source character string. That is to say, the character string extraction part 4 includes the translation source character string in the translation request and transmits it to the communication part 5.

The translation request may include a display specification requested to perform the display on the display 11 as well as the character string to be translated, the translation destination language, and the translation source character string. The display specification indicates information of a maximum display width (a maximum character width) of the character string in the display screen, for example.

The communication part 5 is a communication interface to communicate with the translation result providing server 52 and transmits the translation request including the translation source character string from the character string extraction part 4 to the communication part 6 of the translation result providing server 52.

The translation result providing server 52 includes the communication parts 6 and 9, the translation part 7, the translation result selection part 8, and the satisfaction level DB 10.

The communication part 6 is a communication interface to communicate with the navigation device 51, and the communication part 9 is a communication interface to communicate with the translation server 53. The communication part 6 transmits the translation request received from the communication part 5 of the navigation device 51 to the translation part 7.

The translation part 7 instructs the translation server 53 to translate the translation source character string into the translation destination language in accordance with the translation request via the communication part 9. Upon receipt of the translation result from the translation server 53, the communication part 9 transmits the translation result to the translation result selection part 8.

Herein, the translation result indicates a plurality of character strings (a third character string) translated from the plurality of translation source character string (the second character string) into the translation destination language (the second language). The translation result selection part 8 selects a specific character string from among the plurality of character strings as a true translation result. A method for selecting the translation result is described hereinafter.

The character string selected by the translation result selection part 8 is transmitted from the communication part 6 to the communication part 5 of the navigation device 51. Subsequently, the character string is transmitted from the communication part 5 to the display controller 2, thereby being displayed on the display 11.

When the user specifies the character string of the first language displayed on the display 11 and performs the translation request through the processing described above, the character string is translated into the specific language other than the first language.

The user sees the translation result displayed on the display 11, and subsequently inputs a satisfaction level of the translation result to the navigation device 51 using the input interface which is not shown in the drawings. The input satisfaction level is acquired by the satisfaction level acquiring part 12, transmitted to the translation result providing server 52 via the communication part 5, and then stored in the satisfaction level DB 10. Furthermore, the satisfaction level is also stored in the other language DB 3 if necessary.

The input interface used for inputting the satisfaction level to the navigation device 51 is made up of a button provided in a housing or a remote controller, for example, of the navigation device 51 in a manner similar to the input interface of the translation request. Alternatively, when the display 11 has a configuration of a display provided with a touch panel, the user may input the satisfaction level via a touch operation or a drag operation on the touch panel. In this case, the display 11 doubles as the input interface of the satisfaction level.

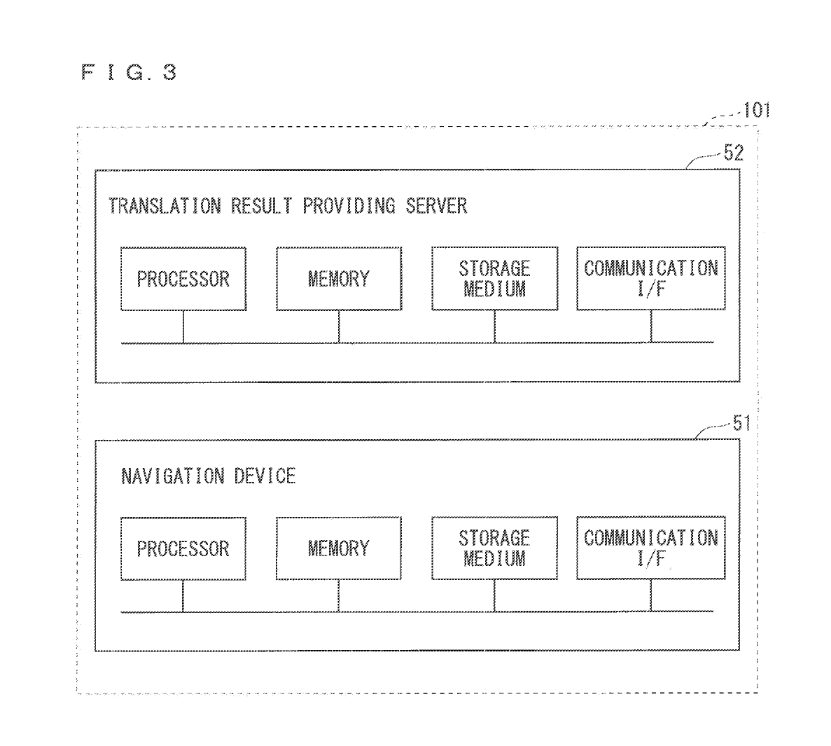

FIG. 3 is a hardware configuration of the multilingual translation device 101. The translation result providing server 52 includes a processor, a memory, a storage medium, and a communication interface. The navigation device 51 includes a processor, a memory, a storage medium, and a communication interface. When the display 11 is included in the configuration of the navigation device 51, the navigation device 51 further includes a display.

In the translation result providing server 52, the translation part 7 and the translation result selection part 8 are achieved when a processor such as a CPU (Control Processing Unit) executes a program stored in a memory such as a RAM (Random Access Memory). The satisfaction level DB 10 is achieved by a storage medium such as an HDD (Hard Disk Drive) and a SD memory card.

In the navigation device 51, the translation request acquiring part 1, the display controller 2, the character string extraction part 4, and the satisfaction level acquiring part 12 are achieved when a processor such as a CPU (Control Processing Unit) executes a program stored in a memory such as a RAM (Random Access Memory). The other language DB 3 is achieved by a storage medium such as an HDD (Hard Disk Drive) and a SD memory card.

### A-3. Operation

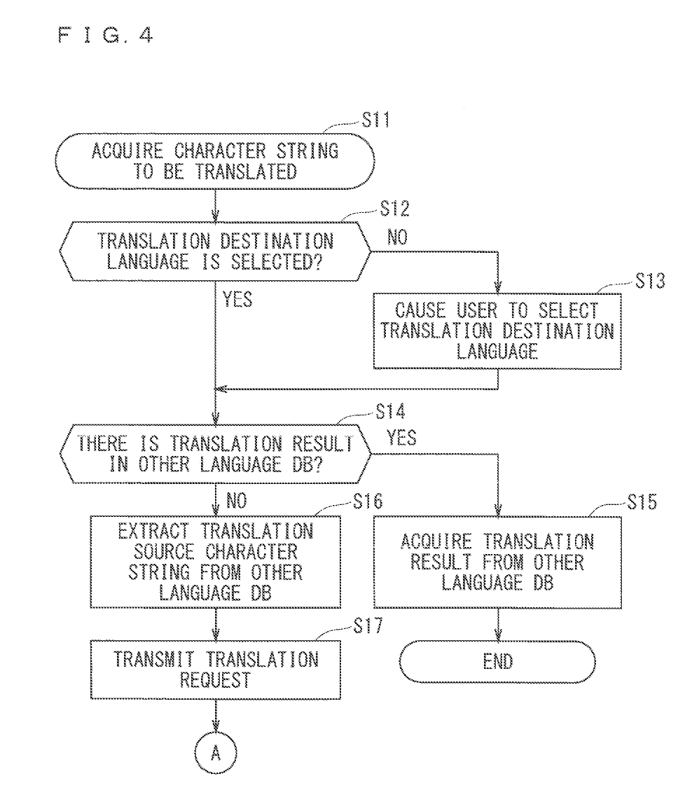

FIG. 4 is a flow chart showing a processing that the navigation device 51 acquires the translation request and then transmits the translation request to the translation result providing server 52. The processing is described along with FIG. 4 hereinafter.

When the translation request acquiring part 1 acquires the character string to be translated (the first character string) of the first language (Step S11), the translation request acquiring part 1 determines whether or not the translation destination language (the second language) is selected (Step S12). The character string to be translated is input by the user specifying the character string on the touch panel with the touch operation and the drag operation, for example, and is transmitted to the translation request acquiring part 1. The translation destination language can be selected in the default setting, for example, and when the translation destination language is selected, the selected translation destination language is held by the translation request acquiring part 1. The translation request acquiring part 1 can determine whether or not the translation destination language is selected based on the information described above.

When the translation destination language is selected, the processing proceeds to Step S14. When the translation destination language is not selected, a selection screen for selecting the translation destination language is displayed on the display 11 under the display control of the display controller 2, the user is caused to select the translation destination language (Step S13), and the processing proceeds to Step S14.

In Step S14, the character string extraction part 4 refers to the other language DB 3 and determines whether or not there is the translation result. When the translation from the character string to be translated, which is the same as the current translation request, into the translation destination language, which is the same as the current one, has been performed previously, the result may be stored in the other language DB 3. A condition for storing the translation result in the other language DB 3 is described hereinafter. When there is the translation result in the other language DB 3 (Step S14: YES), the character string extraction part 4 acquires the translation result from the other language DB (Step S15) and output the translation result to the display controller 2. The translation result is thereby displayed on the display 11 in accordance with the control of the display controller 2.

When there is no translation result in the other language DB 3 (Step S14: NO), the character string extraction part 4 extracts the translation source character string from the other language DB 3 (Step S16). Herein, the character string extraction part 4 extracts, as the translation source character string, the character string of the other language (the second language) corresponding to the translation source character string, that is to say, the same word (the second character string). The accuracy of the translation is improved with the increase in the translation source character string. It is therefore preferable for the character string extraction part 4 to extract the translation source character string for all of the languages whose character strings are stored in the other language DB 3, however, the configuration is not limited thereto. The effect of the present invention can be acquired as long as the character string extraction part 4 extracts the translation source character string for the plurality of languages.

Subsequently, the character string extraction part 4 includes the translation source character string extracted in Step S14 in the translation request, and transmits the translation request to the translation result providing server 52 via the communication part 5 (Step S17). Herein, the translation request includes the information of the character string to be translated, translation destination language, and translation source character string. The translation request may further include the information of the display specification.

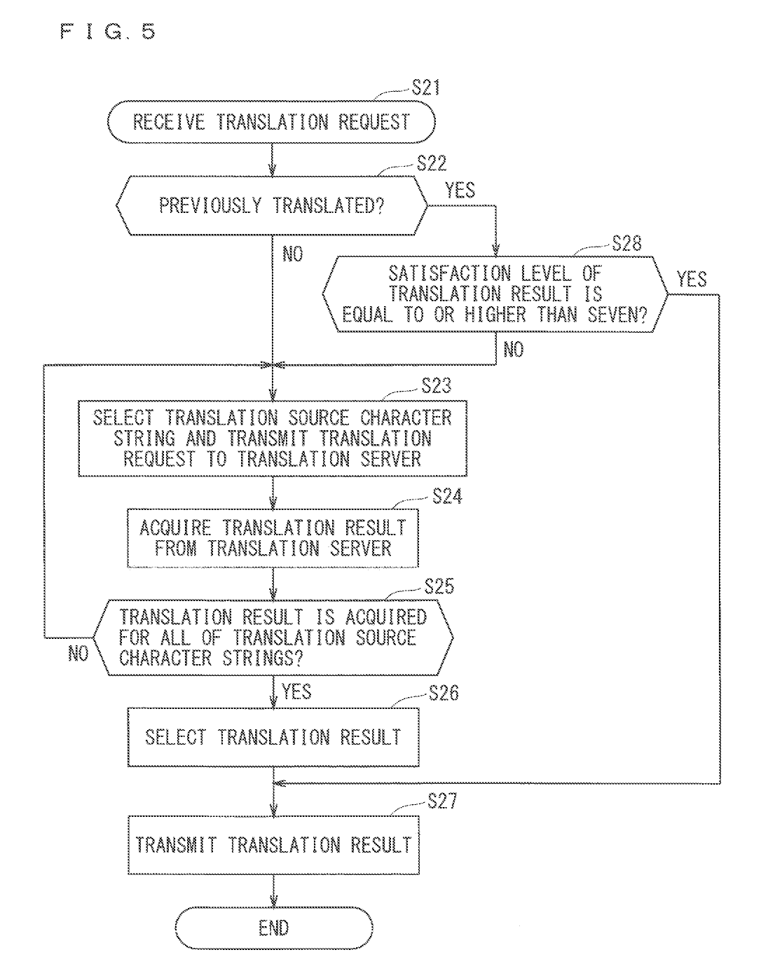

FIG. 5 is a flow chart showing a processing that the translation result providing server 52 receives the translation request from the navigation device 51 and then transmits the translation result to the navigation device 51. The processing is described along with FIG. 5 hereinafter.

Upon receipt of the translation request from the navigation device 51 (Step S21), the translation result providing server 52 determines whether or not the same translation has been performed previously (Step S22). Herein, the translation part 7 refers to the satisfaction level DB 10 and performs the determination. The result of the translation which has been performed by the translation server 53 previously and a satisfaction level of the user to the result are associated with each other and stored in the satisfaction level DB 10. The satisfaction level is expressed by a score out of ten. The storage of the data in the satisfaction level DB 10 is described hereinafter. Although FIG. 2 illustrates a state where one navigation device 51 is connected to the translation result providing server 52, the plurality of navigation devices 51 are actually connected to the translation result providing server 52. The translation requests are transmitted from the plurality of navigation devices 51 to the translation result providing server 52, and each translation result is stored in the satisfaction level DB 10 together with the satisfaction level.

When the satisfaction level DB 10 stores the result of the translation from the character string to be translated, which is the same as the current translation request, into the translation destination language, which is the same as the current one, the translation part 7 determines that the same translation has been performed previously (Step S22: YES). Then the translation part 7 determines that whether or not the satisfaction level of the translation result is equal to or higher than seven (Step S28). When the satisfaction level is not equal to or higher than seven, the processing proceeds to Step S23. The processing also proceeds to Step S23 when the same translation has not been performed previously (Step S22: NO).

In Step S23, the translation part 7 selects one of the translation source character string according to the translation request, and performs the translation request on the translation server 53 via the communication part 9. The translation server 53 performs the translation from the translation source character string into the character string of the translation destination language (the third character string). Upon receipt of the translation result (the third character string) from the translation server 53 (Step S24), the communication part 9 transmits the translation result to the translation result selection part 8.

Subsequently, the translation result selection part 8 determines whether or not the translation result is acquired for all of the translation source character strings (Step S25), and repeats Step S23 to Step S25 until the translation request is finished for all of the translation source character strings.

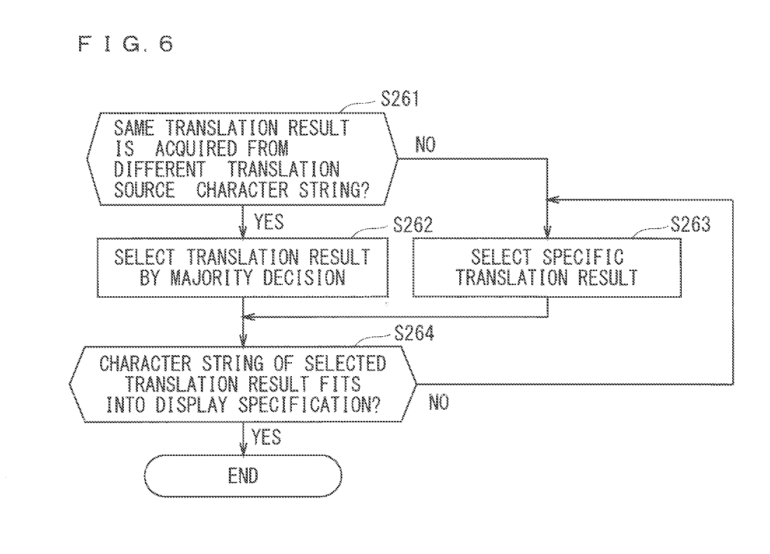

When the translation result selection part 8 acquires the translation result for all of the translation source character strings (Step S25: YES), the translation result selection part 8 selects the specific translation result (Step S26) from the translation result. The detail of the selection processing is described hereinafter in FIG. 6.

The selected translation result is transmitted from the communication part 6 to the navigation device 51 (Step S27). When the same translation has been performed previously and the satisfaction level of the translation result is equal to or higher than seven (Step S28: YES), the translation result providing server 52 acquires the translation result from the satisfaction level DB without performing the translation in the translation server 53 and transmits the translation result to the navigation device 51 (Step S27). Accordingly, the trouble of performing the same translation repeatedly can be avoided. Since the satisfaction level DB 10 also stores the translation result of the translation request from the other navigation device 51, the translation result can be acquired using the translation request performed by the other user. Furthermore, since only the translation result having the high satisfaction level is used, the highly accurate translation result can be acquired.

FIG. 6 is a flow chart showing a detail of a selection processing of the translation result corresponding to Step S26 of FIG. 4. The processing is described along with FIG. 6 hereinafter.

When the translation result selection part 8 acquires the result of the translation performed by the translation server 53 from all of the translation source character strings, the translation result selection part 8 determines whether or not the same translation result is acquired from the different translation source character string (Step S261).

When the same translation result is acquired from the different translation source character string, the translation result selection part 8 selects the translation result by majority decision (Step S262). For example, in a case where there are the seven translation source character strings, and in the seven translation source character strings, a translation result A is acquired from the four translation source character strings, a translation result B is acquired from the two translation source character strings, and a translation result C is acquired from the one translation source character string, the translation result selection part 8 selects the translation result A by the majority decision. The reason is that the accuracy in the translation result is deemed to be high as the same translation result acquired from the translation source character strings of many different languages increases in number.

In the above manner, the translation accuracy is improved by selecting the translation result based on the number of translations from the translation source character string into the same character string.

The term “the same translation result” indicates that the character string is completely the same when the translation source character string is made up of a word. When the translation source character string is made up of a sentence, it is applicable to determine that the translation result is the same in a case where the character string is completely the same, or it is also applicable to determine that the translation result is the same even when there is a slight difference such as the difference of word order.

When the same translation result cannot be acquired from the different translation source character string, that is to say, when the results of the translations from all of the translation source character strings are different, the translation result selection part 8 selects the one specific translation result (Step S263). For example, the translation result selection part 8 can predetermine a priority order of selecting the translation result for each language, and can select the translation result from the translation source character string of the language having the highest priority. The priority order may also be uniformly determined regardless of the translation destination language. Alternatively, the priority order may also be determined in accordance with a relationship with the translation destination language. For example, when the translation destination language is German, English, which is a Germanic language as with German, has the higher priority than Italian, and when the translation destination language is Portuguese, Italian, which is a Latin language as with Portuguese, has the higher priority than English.

When the translation result selection part 8 selects the translation result in Step S262 or Step S263, the translation result selection part 8 determines whether or not the character string of the translation result fit into the display specification (Step S264). Herein, the translation result selection part 8 determines whether or not the character string of the translation result fits into the maximum character width. When the character string of the translation result does not fit into the display specification, the processing proceeds back to Step S263, and the translation result selection part 8 selects the other translation result.

When the translation result acquired from the largest number of translation source character strings does not satisfy the display specification, the translation result acquired from the second largest number of translation source character strings is selected. When there is no translation result acquired from the second largest number of translation source character strings, the translation result is selected in accordance with the priority order for each language.

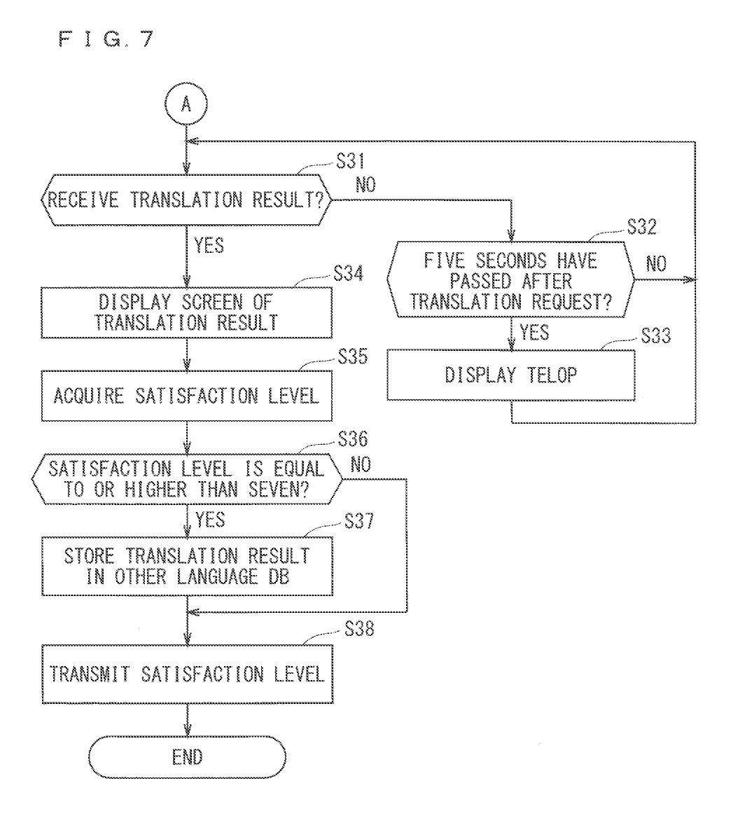

FIG. 7 is a flow chart showing a subsequent processing of the navigation device 51 which has transmitted the translation request to the translation result providing server 52. The processing is described along with FIG. 7 hereinafter.

The navigation device 51 transmits the translation request to the translation result providing server 52 in Step S17 of FIG. 4, and subsequently stands by for the receipt of the translation result from the translation result providing server 52. When five seconds have passed after the translation request without receiving the translation result (Step S31: NO), the display controller 2 displays a telop for promoting the waiting such as “It takes time to perform the translation. Please wait.” on the display 11 (Step S33). The telop is displayed in the language specified by the user in the default setting (the first language), for example.

Upon receipt of the translation result from the translation result providing server 52 (Step S31: YES), the display controller 2 displays the translation result on the display 11 (Step S34). The character string specified by the user is thereby translated into the language which the user can understand and displayed. For example, when the user can slightly understand English but the navigation device 51 does not correspond to the native language, that is to say, when the character string of the native language is not stored in the other language DB 3, the navigation device 51 can be used in a state where English is specified as the first language, and the character string which the user cannot understand can be specified as needed and translated into the native language.

The user sees the translation result displayed on the display 11 and inputs the satisfaction level of the translation result. Herein, a screen for inputting the satisfaction level may be displayed at the time of displaying the translation result. The satisfaction level is an index indicating the extent to which the user is satisfied with the translation result, and in the following description, the satisfaction level is expressed by a score out of ten. It is deemed that the highly accurate translation is performed as the satisfaction level increases.

When the satisfaction level acquiring part 12 acquires the satisfaction level (Step S35), the satisfaction level acquiring part 12 determines whether or not the satisfaction level is equal to or higher than seven (Step S36), and stores the translation result in the other language DB 3 when the satisfaction level is equal to or higher than seven (Step S37). In contrast, the translation result whose satisfaction level is lower than seven is not stored in the other language DB 3. Specifically, the character string to be translated, the translation destination language, and the translation result are associated with each other and stored in the other language DB 3. Since the translation result is stored in the other language DB 3 as described above, when the same translation request is performed again, the translation result having the high satisfaction level can be taken out from the other language DB 3 and displayed rapidly without the translation performed by the translation server 53 (Steps S14 and S15 of FIG. 4).

The satisfaction level acquiring part 12 transmits the satisfaction level to the communication part 5 and transmits the satisfaction level from the communication part 5 to the translation result providing server 52 (Step S38). The satisfaction level transmitted to the communication part 6 of the translation result providing server 52 is transmitted from the communication part 6 to the translation part 7, and is then stored in the satisfaction level DB 10 by the translation part 7. Specifically, the character string to be translated, the translation destination language, the translation result, and the satisfaction level are associated with each other and stored in the satisfaction level DB 10.

Although only the translation result having the high satisfaction level (equal to or higher than seven in the above example) is stored in the other language DB 3 of the navigation device 51, all of the translation results may be stored in the satisfaction level DB 10.

### A-4. Modification Example

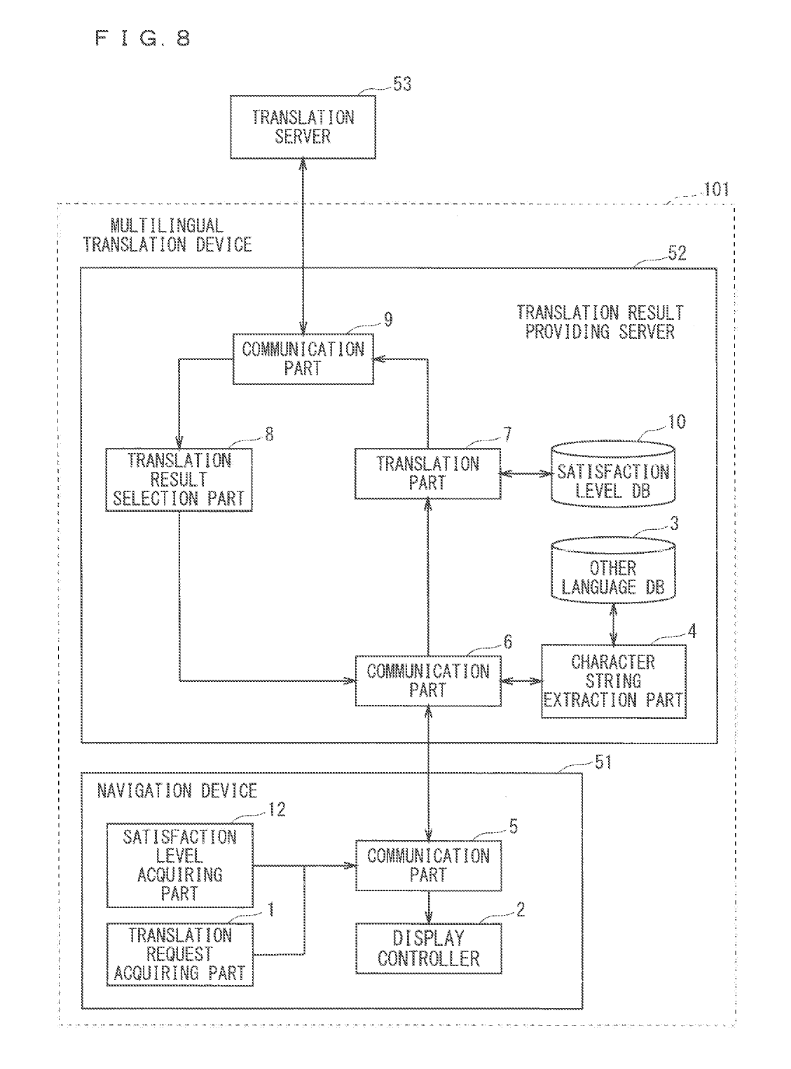

FIG. 2 illustrates the configuration that each configuration of the multilingual translation device 101 is disposed separately in the navigation device 51 and the translation result providing server 52, however, its separation aspect can be optionally changed within the scope for solving the problem of the present invention. FIG. 8 is a block diagram illustrating a configuration of the multilingual translation device 101 in which the separation aspect is changed. As shown in FIG. 8, the other language DB 3 and the character string extraction part 4 may be provided in the translation result providing server 52 instead of the navigation device 51. In FIG. 8, the illustration of the display 11 is omitted. FIG. 2 illustrates the translation server 53 and the translation result providing server 52 as the separated configurations, however, the translation server 53 and the translation result providing server 52 may be made up of the same server. The part of the configuration of the multilingual translation device 101 may be achieved by a mobile terminal.

In the above description, the translation result selection part 8 selects one of the translation results. However, the translation result selection part 8 may select a plurality of translation results in descending order according to majority decision, or may select a plurality of translation results based on a priority order determined in the language of the translation source language. Then, the translation result selection part 8 may cause the display 11 to display the plurality of translation results so that the user selects one of the translation results. The above configuration has the effect that the user can easily select the highly accurate translation result in accordance with a user's intention.

### A-5. Effect

The multilingual translation device 101 according to the embodiment 1 includes the translation request acquiring part 1 that acquires the translation request to translate the first character string of the first language into the second language, the character string extraction part 4 that extracts, when the character string data of the second language is not stored in the other language DB 3 (the storage) storing the character string data of the plurality of languages including the first language, the second character string corresponding to the first character string from the other language DB 3 for each of the plurality of languages whose character string data is stored in the other language DB 3, the translation part 7 that translates the second character string into the third character string of the second language using the translation server 53, and the translation result selection part 8 that selects the specific character string in the third character string as the translation result. According to the configuration that the translation is performed on the plurality of second character strings of the different languages and the translation result is selected, the accuracy of the translation is improved compared with the case where the translation is performed on the first character string. Since the translation into the language whose character string is not stored in the other language DB 3 can be performed by the translation server 53, it is possible to correspond to the multiple languages at low cost.

Since the translation result selection part 8 selects the translation result based on the number of translations translated from the second character string into the same character string, the translation accuracy is improved.

Furthermore, since the translation result selection part 8 selects, as the translation result, the third character string translated from the second character string of the largest number of languages into the same character string, the translation accuracy is improved.

Alternatively, the translation result selection part 8 selects the translation result from among the predetermined number of character strings in descending order according to the number of translations translated from the second character string into the same character string. In the above case, when the selected plurality of translation results are provided to the user and the user selects the translation result, it is possible to cause the user to select the most probable translation result.

Alternatively, the translation result selection part 8 selects the translation result based on the priority order predetermined for the language of the second character string. In the above case, when the priority order of the language similar to the translation destination language is raised, for example, the highly accurate translation result can be selected.

The multilingual translation device 101 includes the display controller 2 which causes the display 11 to display the waiting state using the character string of the second language stored in the other language DB 3 (the storage) when the predetermined period of time or more is required for the translation performed by the translation server 53. Accordingly, usability of the user can be improved.

The translation result selection part 8 selects the third character string which fits into the display specification in the display 11 as the translation result. Accordingly, the state where the translation result is not appropriately displayed on the display 11 can be avoided.

The multilingual translation device 101 includes the satisfaction level acquiring part 12 which acquires the satisfaction level of the user to the translation result selected by the translation result selection part 8 and the satisfaction level DB 10 (the satisfaction level storage) which stores the translation result and the satisfaction level in association with each other. When the translation result of the first character string of the first language translated into the second language is stored in the satisfaction level DB 10 and the satisfaction level of the translation result is higher than the threshold value, the translation part 7 acquires the translation result from the satisfaction level DB 10 without the translation performed by the translation server 53. Accordingly, the translation result can be rapidly provided to the user using the result of the translation which has been performed previously.

The multilingual translation method according to the embodiment 1 includes: acquiring the translation request of translating the first character string of the first language into the second language; extracting, when the character string data of the second language is not stored in the other language DB 3 (the storage) storing the character string data of the plurality of languages including the first language, the second character string corresponding to the first character string from the other language DB 3 for each of the plurality of languages whose character string data is stored in the other language DB 3, translating the second character string into the third character string of the second language using the translation server 53, and selecting the specific character string in the third character string as the translation result. According to the configuration that the translation is performed on the plurality of second character strings of the different languages and the translation result is selected, the accuracy of the translation is improved compared with the case where the translation is performed on the first character string. Since the translation into the language whose character string is not stored in the other language DB 3 can be performed by the translation server 53, it is possible to correspond to the multiple languages at low cost.

According to the present invention, each embodiment can be appropriately varied or omitted within the scope of the invention.

The present invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1 Translation request acquiring part, 2 Display controller, 3 Other language DB, 4 Character string extraction part, 5, 6, 9 Communication part, 7 Translation part, 8 Translation result selection part, 10 Satisfaction level DB, 11 Display, 12 Satisfaction level acquiring part, 51 Navigation device, 52 Translation result providing server, 53 Translation server, 100, 101 Multilingual translation device

1-9. (canceled)

10. A multilingual translation device that translates a character string displayed on a display, comprising:
a processor to execute a program,
a storage to store a character string data of a plurality of languages including a first language; and
a memory to store said program which, when executed by said processor, performs processes of,
acquiring a translation request to translate a first character string of said first language into a second language;
extracting, when a character string data of said second language is not stored in said storage, a second character string corresponding to said first character string from said storage for each of a plurality of languages whose character string data is stored in said storage;
translating said second character string into a third character string of said second language using a translation server;
selecting a specific character string in said third character string as a translation result;
acquiring a satisfaction level of a user to said translation result;
storing said translation result and said satisfaction level in association with each other in said storage; and
acquiring, when said translation result of said first character string of said first language translated into said second language is stored in said storage and a satisfaction level of said translation result is higher than a threshold value, said translation result from said storage without a translation performed by said translation server.

11. The multilingual translation device according to claim 10, wherein
said translation result is selected based on a number of languages of said second character string of translation source from said third character string.

12. The multilingual translation device according to claim 11, wherein
said third character string having a largest number of languages of said second character string of translation source is selected as said translation result.

13. The multilingual translation device according to claim 11, wherein
said translation result is selected from among a predetermined number of said third character strings in descending order according to a number of languages of said second character string of translation source.

14. The multilingual translation device according to claim 10, wherein
said translation result is selected based on a predetermined priority order for a language of said second character string.

15. The multilingual translation device according to claim 10, wherein,
when said program is executed by said processor, said display is caused to display a waiting state using a character string of said second language stored in said storage when a predetermined period of time or more is required for a translation performed by said translation server.

16. The multilingual translation device according to claim 10, wherein
said third character string fitting into a display specification in said display is selected as said translation result.

17. A multilingual translation method for translating a character string displayed on a display, comprising:
acquiring a translation request of translating a first character string of a first language into a second language;
extracting, when a character string data of said second language is not stored in a storage storing a character string data of a plurality of languages including said first language, a second character string corresponding to said first character string from said storage for each of a plurality of languages whose character string data is stored in said storage;
translating said second character string into a third character string of said second language using a translation server;
selecting a specific character string in said third character string as a translation result;
acquiring a satisfaction level of a user to said translation result;
storing said translation result and said satisfaction level in association with each other in said storage; and
acquiring, when said translation result of said first character string of said first language translated into said second language is stored in said storage and a satisfaction level of said translation result is higher than a threshold value, said translation result from said storage without a translation performed by said translation server.
